(19) United States
(12) Patent Application Publication
(10) Pub. No.: US 2008/0229358 A1
(43) Pub. Date: Sep. 18, 2008

(54) Program selection assistant for IP TV

(75) Inventor: Ate Sander Van Steenbergen, Groningen (NL)

Correspondence Address: MICHAELSON & ASSOCIATES, P.O. BOX 8489, RED BANK, NJ, 07701-8489, US

(73) Assignee: KONINKLIJKE KPN N.V., The Hague (NL)

(21) Appl. No.: 12/012,604

(22) Filed: Feb. 4, 2008

(30) Foreign Application Priority Data
Feb. 2, 2007 (EP) 07002258.7

(51) Int. Cl. H04N 5/445

(52) U.S. Cl. 725/40

(57) ABSTRACT

A method and a system are disclosed for providing program selection information to users of IP TV services. The program selection information provides users with real-time information about the viewing behavior of other users. The program selection information can be used by a user to select a particular television program, and can be used in addition to the information that is contained in an electronic program guide (EPG).

### FIELD OF THE INVENTION

The present invention relates to a method for providing information to a user relating the viewing behavior of other users of IP TV services.

### BACKGROUND OF THE INVENTION

IP TV (Internet Protocol Television) is a system where a digital television service is delivered using the Internet Protocol over a network infrastructure, which may include delivery by a broadband connection. IP TV can be provided in conjunction with Video on Demand and may be bundled with Internet services such as Web access and VoIP. The commercial bundling of IP TV, VoIP and Internet access is referred to as a Triple Play. In an IP TV system there is often an Electronic Program Guide (EPG) available for the users of IP TV services. The EPG is an on-screen guide to scheduled broadcast television programs, allowing a user to navigate, select, and discover content by time, title, channel, etc, by use of their remote control.

By navigating through an EPG on a receiving device (e.g., television set/set-top box), users can see more information about television programs. Typical elements of an EPG comprise a graphical user interface which enables the display of program titles, and descriptive information relating the television programs (e.g., actors, directors, year of production, program start times). The information can be displayed on a grid with the option to select more information on each program. EPGs can be sent within a broadcast transport data stream or alongside it in a special data channel.

### 1. Problem Definition

However, the prior art fails to disclose other information than the information contained by an EPG that can be used by a user to select a particular television program.

### 2. Aim of the Invention

It is an object of the invention to eliminate the drawbacks of the prior art and to provide a method and a system for providing users of IP TV services with information with regard to the viewing behavior of other users.

### SUMMARY OF THE INVENTION

In accordance with this invention, a method is disclosed for providing program selection information to an end-user device, the method comprising the step of collecting by a program selection assistant measurement information from one or more signal distribution devices, a signal distribution device being connected to an IP based network, and the IP based network being used for distributing one or more television channels from a IP TV platform to one or more user environments, the method further comprising the steps of:

processing said measurement information into program selection information; and

transporting the program selection information to said end-user device.

In a first aspect of the invention a program selection assistant disclosed for providing, via an end-user device, users with information (program selection information) about the viewing behavior of the users of IP TV services. The end-user device can be any type of digital device such as a television device, a personal computer, a handheld device or a mobile telephone. The program selection assistant can be connected to an IP based network that is used to transport data streams from an IP TV platform to a user environment comprising for instance a television set and a set-top box. It is disclosed that the program selection assistant is able to communicate to DSLAMs connected to the IP based network in order to collect information from the DSLAMs (9). This information is for example information about the number of set-top boxes at a certain moment of time that have selected one particular data stream. This is possible because information is logged by the DSLAMs. Because this logging takes place instantaneously or nearly instantaneously it is possible to have a real-time overview of the number of users that are viewing a particular television channel at a certain moment in time. The transport of information from the DSLAMs to the program selection assistant can be via any type of network, for instance via the IP based network. The information received from the DSLAMs is processed by the program selection assistant into program selection information. The program selection information can for instance be transported to a mobile device via a network. If the program selection information is to be displayed on a television device, the program selection assistant can be connected to the IP based network in order to communicate the program selection information to the IP TV platform.

In another aspect of the invention it is disclosed that the program selection assistant may comprise a collection unit, processing unit and a presentation unit. The units comprised by the program selection assistant are not required to be residing at the same physical location. For instance, the collect unit and the processing unit may be comprised by a server in or connected to the IP based network, while the presentation unit may be comprised by an end-user device. The latter unit may for instance be software that is comprised by an UMTS mobile telephone.

The program selection assistant may be able to process the collected information received from one or more DSLAMs resulting in program selection information. For instance, the received information can be arranged in a predetermined order or cumulated. If the program selection information is to be shown to the user via the television set, the program selection information can be transported from the processing unit via the IP based network to the IP TV platform. At the IP TV platform the program selection information can be included in a particular data stream so that the program selection information is available to the user by selecting a particular television program (for instance a service channel). The presentation unit may in such a case be residing at the IP TV platform, at the set-top box or at the television set.

If the program selection information is to be presented via a personal computer or any other type of computer device such as a UMTS mobile telephone, the program selection assistant can be accessible to the user by means of a web page. The web page representing the program selection assistant, can recommend the user to watch a particular program based on the program selection information and optionally also on one or more characteristics of the user.

An advantage of the present invention is that, based on information available in the DSLAMs a user can be informed real-time or nearly real-time about the viewing behavior of other users. The program selection information provided to the user can be used by the user to make a choice between the television programs that are available via his set-top box. Another advantage of the present invention is that a user can receive program selection information via another network than the network that is used for providing IP TV service to the user.

### BRIEF DESCRIPTION OF THE DRAWING FIGURES

The foregoing aspects and many of the attendant advantages of this invention will become better understood by reference to the following detailed description, when taken in conjunction with the accompanying drawing, wherein:

FIG. 1 is a block diagram illustrating an architecture for providing IP TV services to users.

FIG. 2 is a block diagram depicting a possible embodiment of the present invention.

### EXEMPLARY EMBODIMENTS

For the purpose of teaching of the invention, preferred embodiments of the method and devices of the invention are described in the sequel. It will be apparent to the person skilled in the art that other alternative and equivalent embodiments of the invention can be conceived and reduced to practice without departing form the true spirit of the invention, the scope of the invention being limited only by the appended claims as finally granted.

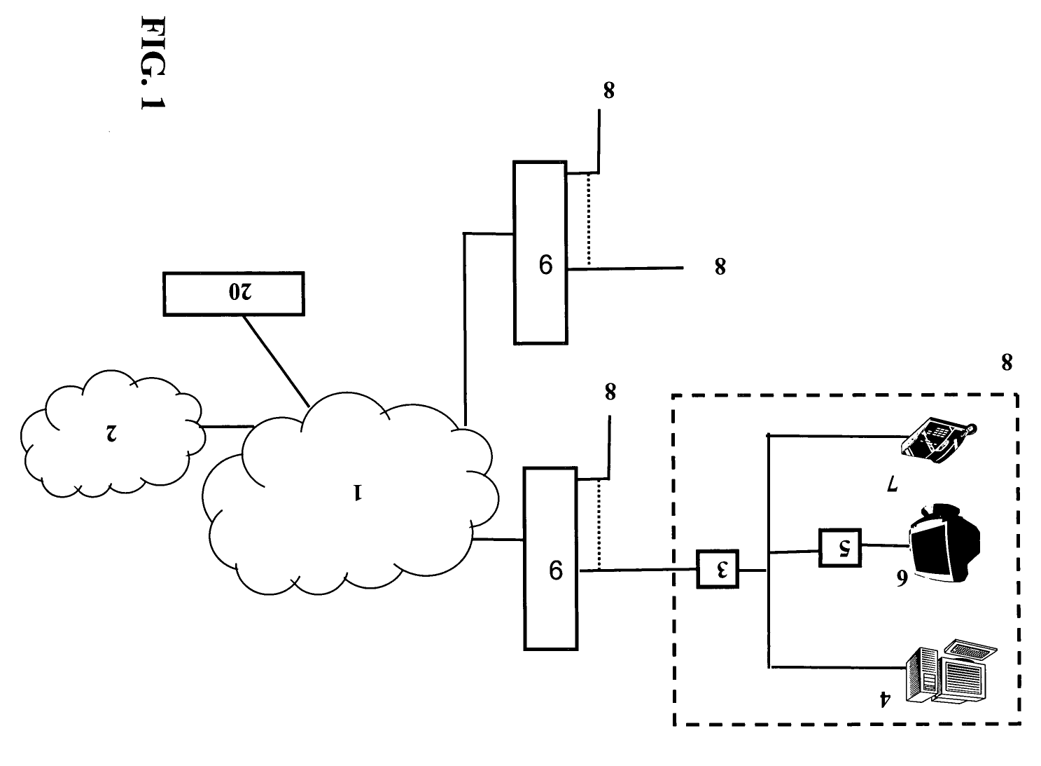

In FIG. 1 an IP based network (1), such as the Internet or a private IP network, is depicted via which communications services such as triple play (telephony, television, data) services can be provided to users. The IP based network (1) can be based on any type of communication technology, such as FTTH (fiber to the home), ADSL or VDSL. It may also be possible that the IP based network (1) is a mobile network or that the IP based network (1) comprises network segments based on mobile technology. The IP based network can be connected to a network (2). For instance, if the IP based network (1) is a privately operated network, the network (2) can be the Internet.

An IP TV platform (20) is connected to the IP based network (1), which is depicted in FIG. 1. A DSLAM (9) (Digital Subscriber Line Access Multiplexer) is connected to the IP based network (1) and to a user environment (8). There can be several user environments (8) connected to a DSLAM (9), and there can be several DSLAMs (9) connected to the IP based network (1).

The DSLAM (9) is in general part of an access infrastructure and may or may not be operated by the same party that operates the IP based network (1). A DSLAM (9) takes connections from many users and aggregates them onto a single, high-capacity connection to the IP based network (1). A DSLAM (9) is generally flexible and able to support multiple types of DSL (Digital Subscriber Line) in a single central office, and different varieties of protocol and modulation. For example, different user environments (8) may be connected via a copper wire (xDSL) to the DSLAM (9). The user environment (8) can be connected to the DSLAM (9) by means of a residential gateway (3). End-user devices may for instance be a personal computer (4) via which data or Internet services can be provided, a television device (6) that is connected to the residential gateway (3) via a set-top box (STB) (5) for the management and selection of IP TV and or Video on demand (digital and/or interactive television), and an IP telephone (7) for providing telephony services. The provisioning of this combination of services is often called triple play. There may be no residential gateway (3) be present in the user environment at all. This is the case when television, telephony and data/Internet are not integrated. The set-top box (5) is then for instance connected to the DSLAM (9) via a DSL modem.

The IP TV platform (20) may comprise a network interface for transmitting content via the IP based network (1) to the user location (8). One or more television channels can be broadcasted by the IP TV platform (20). However, other types of distribution concepts may be used instead of or additional to broadcasting, such as multicasting. The content distributions system (20) may also comprise one or more media servers on which video and audio content is residing. There can be for instance one server being comprised by the IP TV platform for each television channel that is broadcasted.

Each television channel is broadcasted to the DSLAMs (9) by means of a data stream. A set-top box (5) can select one particular data stream out of a collection of data streams that is provided to a DSLAM (9). For this purpose the Internet Group Management Protocol (IGMP) can be used.

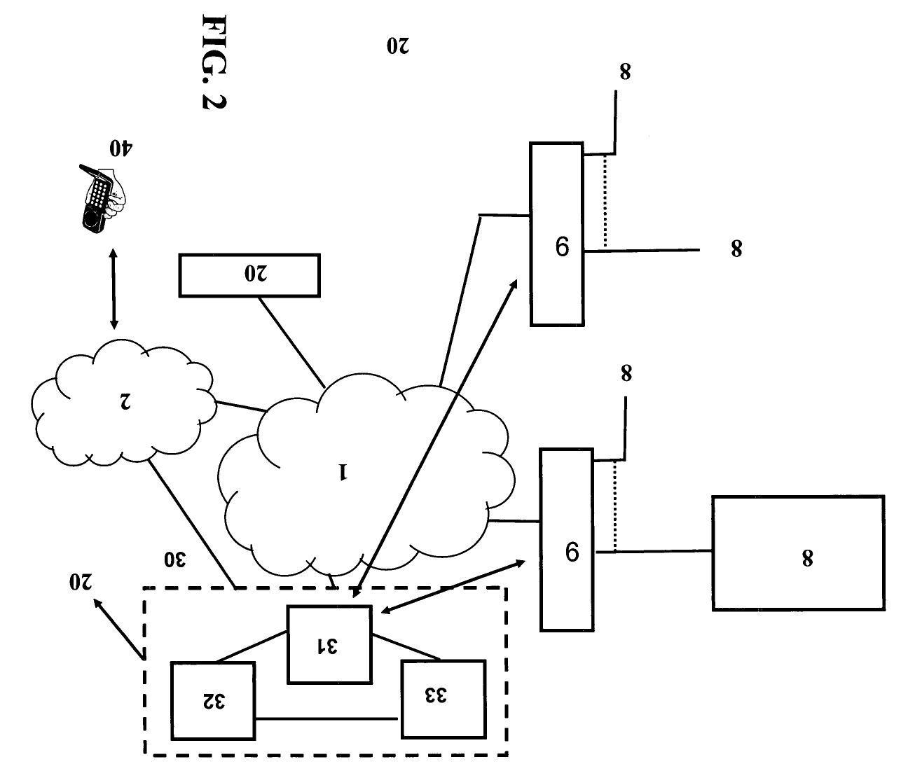

In FIG. 2 a program selection assistant (30) is schematically depicted. By means of the program selection assistant (30) it is possible to provide a user with information (program selection information) with regard to the viewing behavior of the users of IP TV services. This program selection information can be displayed via an end-user device of the user. The end-user device can for instance be a television device (6), a personal computer (5) or a mobile device (40). In the latter case, the program selection assistant (30) is connected to network (2) via network (1)(direct coupling not necessary) in order to be able to communicate the program selection information to the mobile device (40) that is also connected to the network (2). If the program selection information is to be displayed on a television device (6), the program selection assistant (30) is connected to the IP based network (1) in order to communicate with the IP TV platform (20). The program selection assistant (30) comprises a collect unit (31) that is able to communicate to one or more DSLAMs (9) in order to collect measurement information from the DSLAMs (9). This measurement information is for example information about the number of set-top boxes (5) at a certain moment of time that have selected one particular data stream. This is possible because information is logged by a DSLAM (9), such as the (occurrence of) messages that are defines in the IGMP protocol. An example of an IGMP message is the ‘join’ message that is sent by a set-top box (5) to a DSLAM (9) each to a particular television channel is selected.

Because this logging takes place instantaneously or nearly instantaneously it is possible to have a real-time overview of the number of users that are viewing a particular television channel at a certain moment in time. The transport of the measurement information from the DSLAMs (9) to the collect unit (31) of the program selection assistant (30) can be via any type of network, for instance via the IP based network (1).

The program selection assistant (30) also comprises a processing unit (32) that is able to process the measurement information received by the collect unit (31) resulting in program selection information, for instance by ordering or cumulating the measurement information collected by the collect unit (31). Also comprised by the program selection assistant (30) is a presentation unit (33) by which the program selection information can be presented to a user via an end-user device. The collect unit (31), the processing unit (32) and the presentation unit (33) are not required to reside at the same physical location or in the same physical entity. The presentation unit (33) can be a web-server that is connected to the IP based network (1) which is available for the end-user device, e.g., according to a client-server model. In the latter case there is browser software residing at the end-user device, such as a lap-top or an UMTS mobile telephone, via which the web-server can be accessed. The program selection information is displayed, for instance by means of a web page, on a monitor device such as the screen of a mobile telephone. The information on the web page can be a recommendation for the user to watch a particular program. Optionally also on one or more characteristics of the user can be taken into account.

The collect unit (31) and the processing unit (32), however, can be located at a server other than the web-server. The server that facilitates the collect unit (31) and the processing unit (32) can be connected to the IP based network (1) so that the collect unit is able to receive information from the DSLAMs (9).

If the program selection information is to be shown to the user via the television set (6), the program selection information can be transported from the processing unit (32) via an interface unit (34) and the IP based network (1) to the IP TV platform (20). At the IP TV platform the program selection information will be included in a particular data stream (e.g., meta data) so that the program selection information is available to the user by selecting a particular television program (for instance a service channel). The interface unit (34) can be used to provide the program selection information in an appropriate format that is required for enabling the IP TV platform (20) to include the program selection information in meta data. The presentation unit (33) may be residing at the program selection assistant (30) or, in the case that program selection data is included in meta data, at the IP TV platform (20). The presentation unit (33) can exist as a software program by means of which it is possible to present the program selection information in a user friendly way. For instance, a set-top box (5) often comprises a browser. This browser can be used to access the presentation unit (33). The program selection information is then displayed on a monitor device to the user for instance via the television set (6), whereby it may be possible that the user uses a remote control for browsing purposes. In an embodiment of the present invention the program selection information is included in the EPG, for instance by means of showing per program the current number of users viewing that program. A user is then able to select the program that turns out to be the most popular one at a particular moment of time.

An advantage of a method or a system according to the present invention is that, based on measurement information available in the DSLAMs (9) a user can be informed real-time or nearly real-time about the viewing behavior of other users. The program selection information provided to the user can be used by the user to make a choice between the television programs that are available via his set-top box (5). In other words, the program selection assistant (30) provides a user with information informing the user which television programs are popular at a certain moment of time. The user can regard the program selection information as a recommendation to watch one particular television program.

I claim:

1. A method for providing program selection information to an end-user device, the method comprising the step of collecting by a program selection assistant measurement information from one or more signal distribution devices, a signal distribution device being connected to an IP based network, and the IP based network being used for distributing one or more television channels from a IP TV platform to one or more user environments, the method further comprising the steps of:
processing said measurement information into program selection information; and
transporting the program selection information to said end-user device.

2. Method according to claim 1, whereby the measurement information is based upon the receipt by the signal distribution device of one or more IGMP (Internet Group Management Protocol) messages.

3. Method according to claim 1, whereby the signal distribution device is a DSLAM (Digital Subscriber Line Access Multiplexer).

4. Method according to claim 1, whereby said end-user device is a set-top box.

5. Method according to claim 1, whereby said end-user device is a mobile telephone.

6. Method according to claim 1, whereby said end-user device is a personal computer.

7. Method to claim 1, whereby the program selection assistant comprises a collect unit for collecting measurement information from the signal distribution devices, a processing unit for processing the measurement information into program selection information, and a presentation unit for providing the program selection information to said end-user device.

8. Method according to claim 1, whereby the program selection information comprises information relating the actual viewing behaviour of IP TV users.

9. Method according to claim 1, whereby the program selection assistant comprises a web page.

10. Method according to claim 7, whereby the collect unit and the processing unit are residing at a first server that is connected to the IP based network, and whereby the presentation unit is residing at a second server that is also connected to the IP based network.

11. Method according to claim 1, whereby program selection information is transported to said end-user device via the IP based network.

12. Method according to claim 1, whereby program selection information is transported to said end-user device via a network.

13. Method according to claim 11, whereby the program selection information is included in meta data that is sent by the IP TV platform to the signal distribution device.
